(19) United States
(12) Patent Application Publication
(10) Pub. No.: US 2017/0112321 A1
(43) Pub. Date: Apr. 27, 2017

(54) Cooking Device Shaft Assembly

(71) Applicant: Corey John Murray Brown, Freeport (BS)

(72) Inventor: Corey John Murray Brown, Freeport (BS)

(21) Appl. No.: 15/294,686

(22) Filed: Oct. 15, 2016

Related U.S. Application Data
(60) Provisional application No. 62/244,758, filed on Oct. 22, 2015.

(51) Int. Cl. A47J 37/07

(52) U.S. Cl. CPC A47J 37/0745; A47J 37/0786

(57) ABSTRACT

A shaft assembly is provided. The shaft assembly has a shaft, a sprocket, a spring and a shaft retainer. The shaft has a first and second end. A head is disposed on the first end of the shaft. The head is configured not to extend through a first aperture of the front side wall of a cooking device. The second end of the shaft extends through and is rotatably supported by the first aperture. The sprocket and spring are slidably and rotatably disposed on second end of shaft. The second end of the shaft receives a shaft retainer such that the spring is held compressed and self aligns the shaft assembly perpendicular and the sprocket parallel to a side wall and endless chain support members of the cooking device.

### BACKGROUND

Barbecue rotisseries employ a variety of shaft mechanisms to rotate and cook food. One shaft mechanism used in barbecue rotisseries utilizes undesirable larger support structures located at multiple support points to maintain a perpendicular axial shaft alignment to the mounting location. Another shaft mechanism employed in barbecue rotisseries utilizes sprockets requiring hubs for engagement and/or sprocket alignment undesirably increasing manufacturing processes and assembly steps.

The inventor herein has recognized a need for an improved shaft assembly that minimizes and/or reduces the above-mentioned deficiencies.

### SUMMARY

A preferred embodiment of a shaft assembly utilized by a cooking device is provided. The cooking device has a front side wall that has an inner front side communicating with an inner cooking region to cook food therein. The inner front side has an endless chain support. The endless chain support has a first and a second endless chain support member. The front side wall of the cooking device has a first aperture extending therethrough. The shaft assembly has a shaft, a sprocket, a spring and a shaft retainer. The shaft assembly has a first, a second and a third washer. The shaft has a first end and a second end. A head is disposed on the first end of the shaft. The head is configured not to extend through the first aperture of the front side wall. The second end of the shaft is configured to be received through the first aperture into the inner cooking region such that the shaft is rotatably supported by the first aperture. The first washer, second washer, sprocket, third washer and spring are configured to be received respectively by the second end such that they are slidably and rotatably disposed on the shaft. The shaft has a groove therein configured at a predetermined distance from the second end such that when the shaft retainer is received in the groove, the spring is compressed and aligns the shaft substantially perpendicular and the sprocket substantially parallel to the front side wall of the cooking device and the endless chain support members.

An alternative embodiment of a shaft assembly utilized by a cooking device is provided. The cooking device has a front side wall that has an inner front side communicating with an inner cooking region to cook food therein. The inner front side having an endless chain support. The endless chain support having a first and a second endless chain support member. The front side wall of the cooking device has a second aperture extending therethrough. The shaft assembly has a shaft, a sprocket, a spring, and a shaft retainer. The shaft assembly has a first, a second, a third, a forth, a fifth, a sixth and a seventh washer. The shaft has a first end and a second end. A head is disposed on the first end of the shaft. The head is configured to be rotatably coupled and not extend through the second aperture of the front side wall. The front side wall has a motor mount coupled thereon. The motor mount has a motor mount aperture extending therethrough. The motor mount aperture corresponds with the second aperture and is sized to allow the head to rotatably extend therethrough. The first and the second washers are configured to be received respectively by the second end such that they are slidably and rotatably disposed on the shaft. The second end of the shaft is configured to be received through the second aperture into the inner cooking region such that the shaft is rotatably supported by the second aperture. The third and forth washers are configured to be received respectively by the second end such that they are slidably and rotatably disposed on the shaft. The shaft has a shaft engagement portion that extends therein a predetermined distance from the second end. The sprocket has a sprocket face. The sprocket face has a sprocket aperture that is sized and shaped to be received rotatably locked and slidably disposed thereon the shaft engagement portion. The fifth washer, spring, sixth washer and seventh washer are configured to be received respectively by the second end such that they are slidably and rotatably disposed on the shaft. The shaft has a groove therein configured at a predetermined distance from the second end such that when the shaft retainer is received in the groove, the spring is compressed and aligns the shaft substantially perpendicular and the sprocket substantially parallel to the front side wall of the cooking device and the endless chain support members.

### BRIEF DESCRIPTION OF THE DRAWINGS

FIG. 1 is a schematic of a cooking device with a motor, skewers and endless chain removed therefrom, illustrating a preferred embodiment of a shaft assembly and further illustrating an alternative embodiment of a shaft assembly utilized thereon;

FIG. 2 is a cross-sectional view showing the inner front side of FIG. 1 illustrating one preferred embodiment of the shaft assembly and further illustrating one alternative embodiment of the shaft assembly utilized thereon;

FIG. 3 presents an overhead view of the front side wall portion of FIG. 1 illustrating one preferred embodiment of the shaft assembly and further illustrating one alternative embodiment of the shaft assembly utilized thereon;

FIG. 4 is a portion of the front side wall of FIG. 1 illustrating an exploded view of one preferred embodiment of the shaft assembly;

FIG. 5 is an overhead view of a portion of the front side wall of FIG. 1 illustrating one preferred embodiment of the shaft assembly;

FIG. 6 is an underneath view portion of the motor mount and front side wall of FIG. 1 illustrating one alternative embodiment of the shaft assembly;

FIG. 7 presents a forward view portion of a motor mount and front side wall illustrating the shaft assembly of FIG. 1 in accordance with one alternative embodiment;

FIG. 8 presents an overhead angle view portion of the front side wall and the motor mount of FIG. 1 illustrating the shaft assembly in accordance with one alternative embodiment;

FIG. 9 shows a spring utilized in a shaft assembly shaft of FIG. 1 in accordance with one alternative embodiment;

FIG. 10 is a schematic of a sprocket utilized on a shaft of FIG. 11 in accordance with one alternative embodiment of the shaft assembly;

FIG. 11 is a transparent schematic of a shaft utilized in the shaft assembly of FIG. 1 in accordance with one alternative embodiment;

FIG. 12 is a view of a portion of the front side wall illustrating an exploded schematic of one alternative embodiment of the shaft assembly in accordance with FIG. 1;

FIG. 13 is another overhead angle view portion of FIG. 8 illustrating the shaft in accordance with one alternative embodiment;

### DETAILED DESCRIPTION

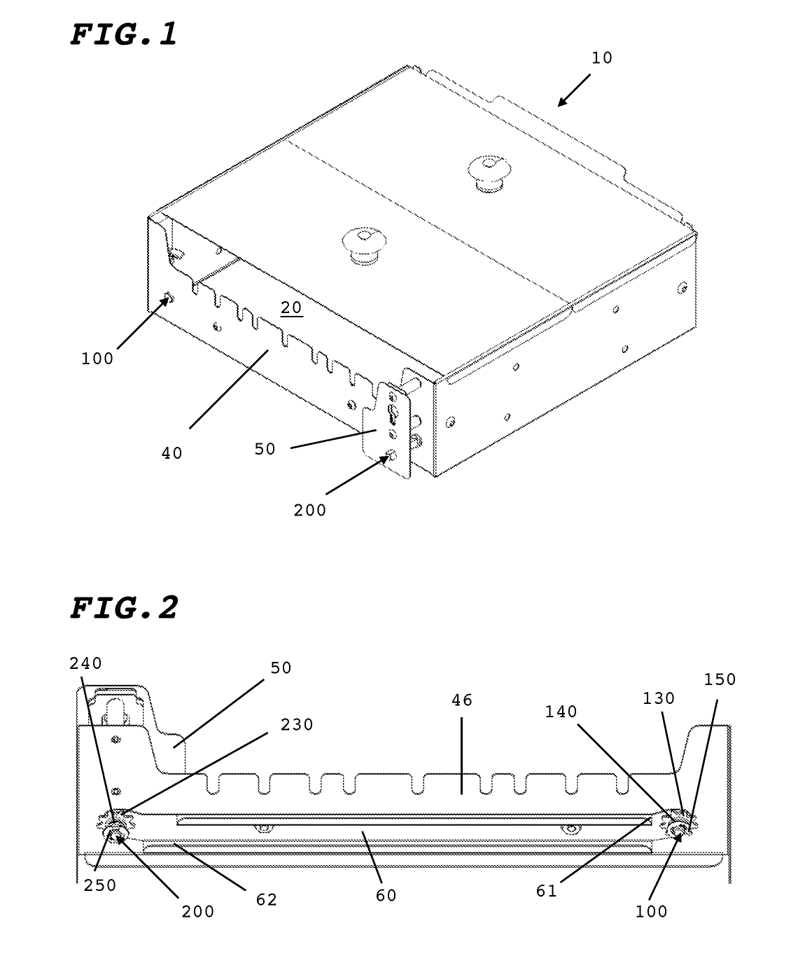

Referring to FIG. 1, a cooking device 10 for grilling or barbecuing food is shown with a motor, skewers and endless chain removed therefrom. The cooking device 10 is utilizing one preferred embodiment of a shaft assembly 100 and one alternative embodiment of a shaft assembly 200. The cooking device 10 having a front side wall 40, a motor mount 50 and an inner cooking region 20 to cook food therein.

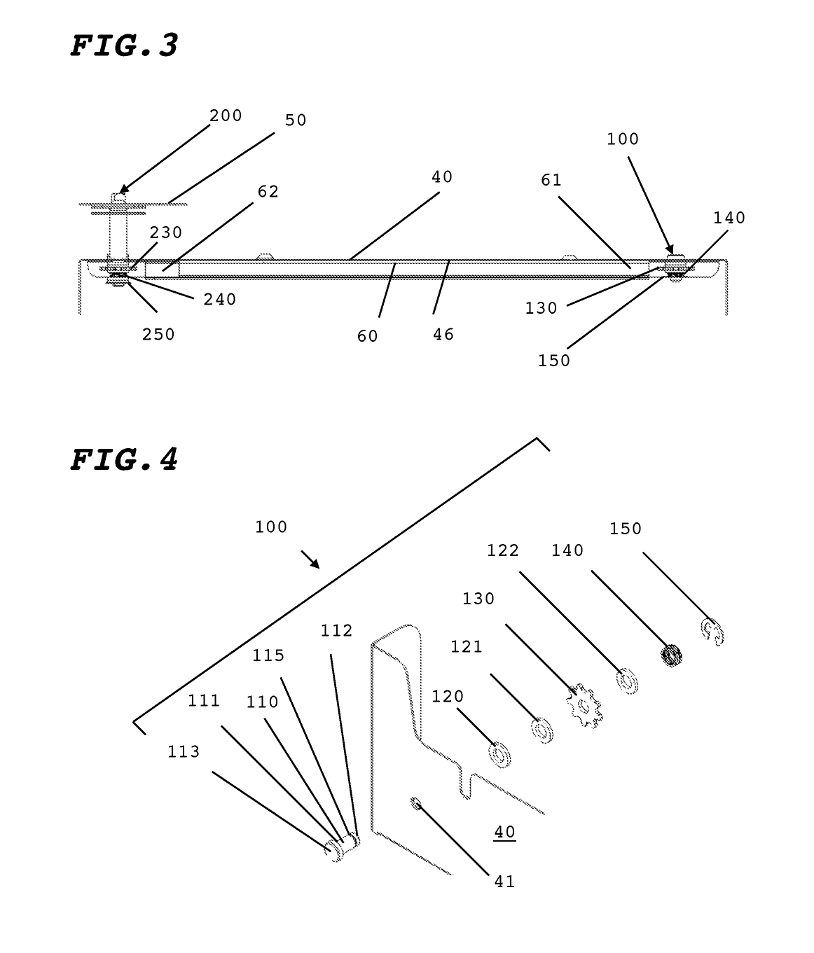

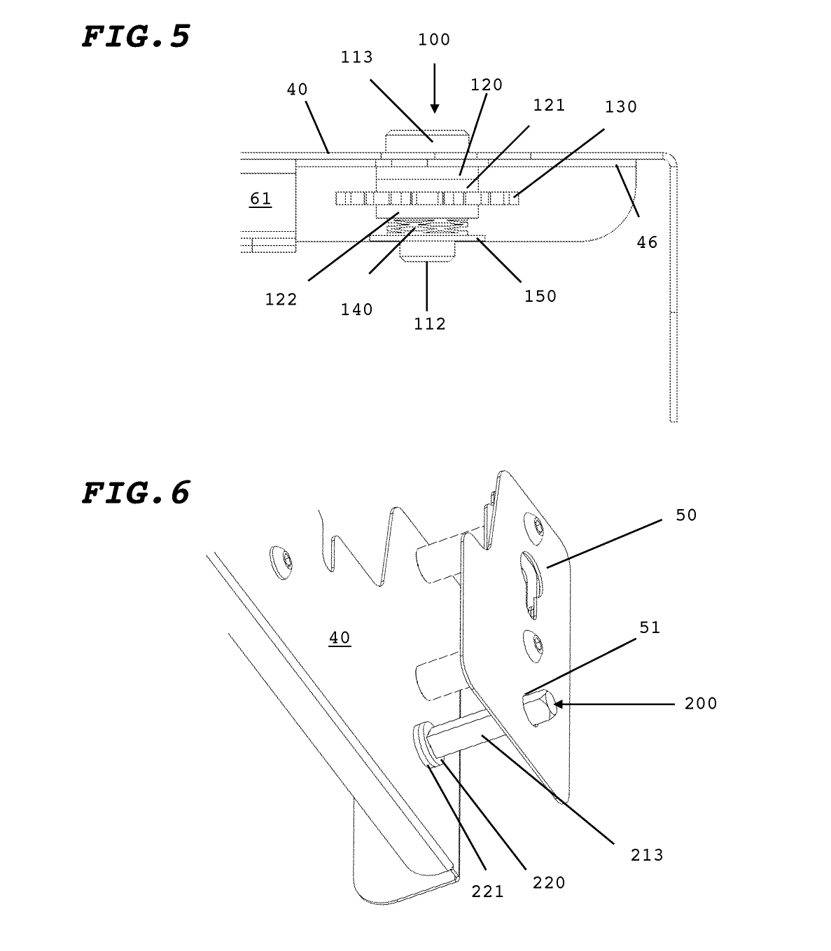

Referring to FIGS. 1-3, 5 and 8, the cooking device 10 having a front side wall 40 that has an inner front side 46 communicating with the inner cooking region 20. The inner front side 46 has an endless chain support 60. The endless chain support 60 having a first and a second endless chain support member 61, 62. The endless chain (not shown) is supported by endless chain support member 61, 62 and received by a sprocket 130 included in the shaft assembly 100 and a sprocket 230 included in the shaft assembly 200.

Referring to FIGS. 1-5, one preferred embodiment of a shaft assembly 100 utilized by a cooking device 10 is provided. The front side wall 40 of the cooking device 10 has a first aperture 41 extending therethrough. The shaft assembly 100 has a shaft 110, washers 120, 121, 122, a sprocket 130, a spring 140 and a shaft retainer 150. The shaft 110 has a first end 111 and a second end 112. A head 113 is disposed on the first end 111 of the shaft 110. The head 113 is configured not to extend through the first aperture 41 of the front side wall 40. An advantage of the shaft assembly 100 is that the second end 112 of the shaft 110 is configured to be received through the first aperture 41 into the inner cooking region 20 such that the shaft 110 is rotatably supported by the first aperture 41 which is less support points than other shaft assemblies. The first washer 120, second washer 121, sprocket 130, third washer 122 and spring 140 are configured to be received respectively by the second end 112 such that they are slidably and rotatably disposed on the shaft 110. The shaft 110 has a groove 115 therein configured at a predetermined distance from the second end 112 such that when the shaft retainer 150 is received in the groove 115, the spring 140 is compressed and provides the technical effect of self aligning the shaft assembly 100 substantially perpendicular and the sprocket 130 substantially parallel to the front side wall 40 of the cooking device and the endless chain support members 61, 62. An advantage of the shaft assembly 100 is that it is self aligning requiring only the first aperture 41 which is a smaller support structure than other shaft assemblies. Of course, in alternative preferred embodiments, any number of washers 120, 121, 122 potentially could be removed or could be included in different combinations depending on the desired application. In an alternative embodiment, the shaft retainer 150 could be a different retainer such as snap ring or push on retainer for example.

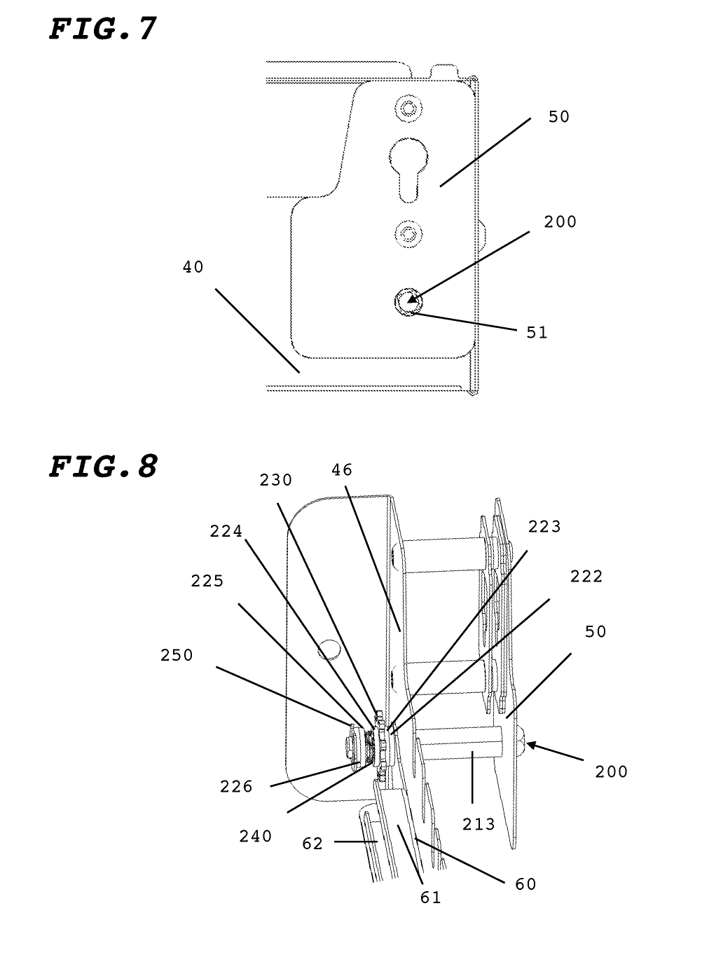

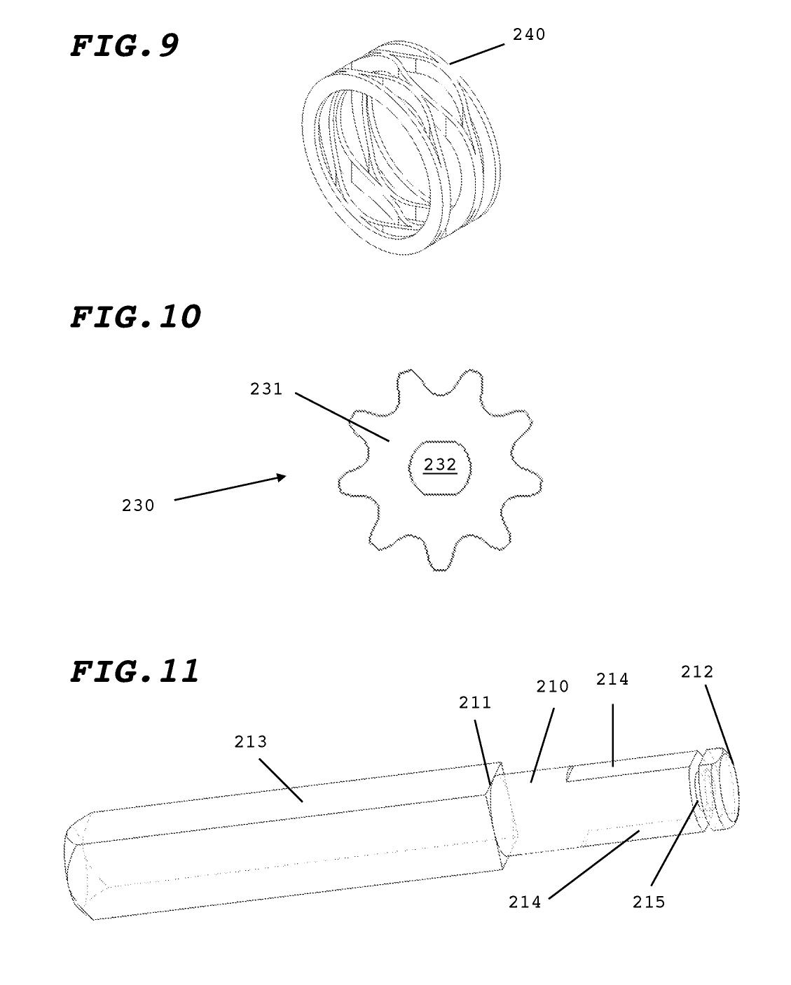

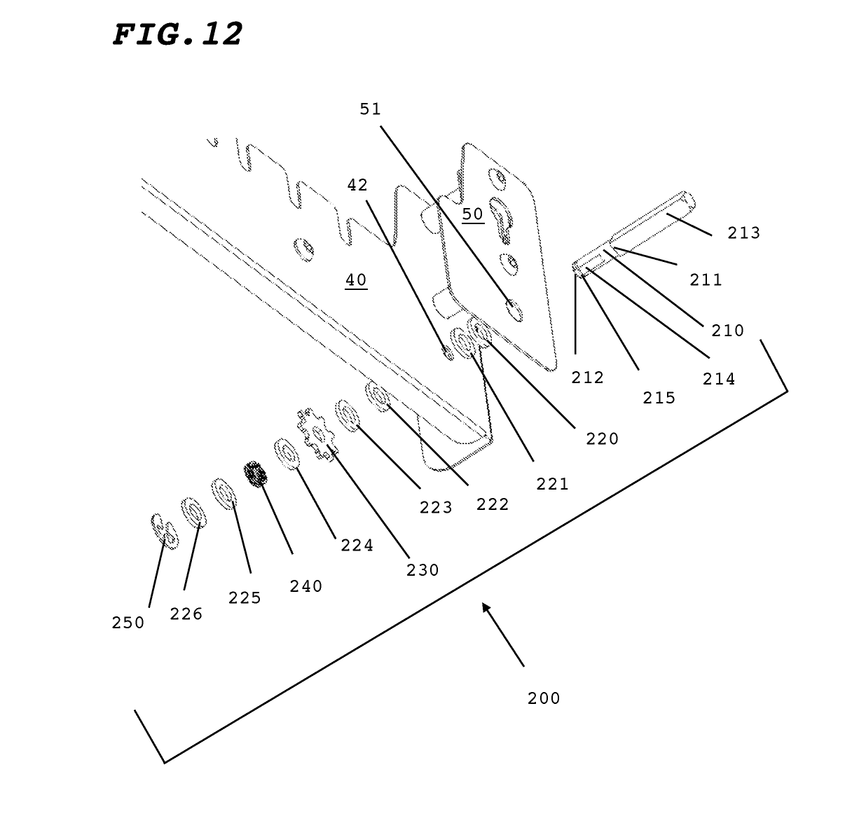

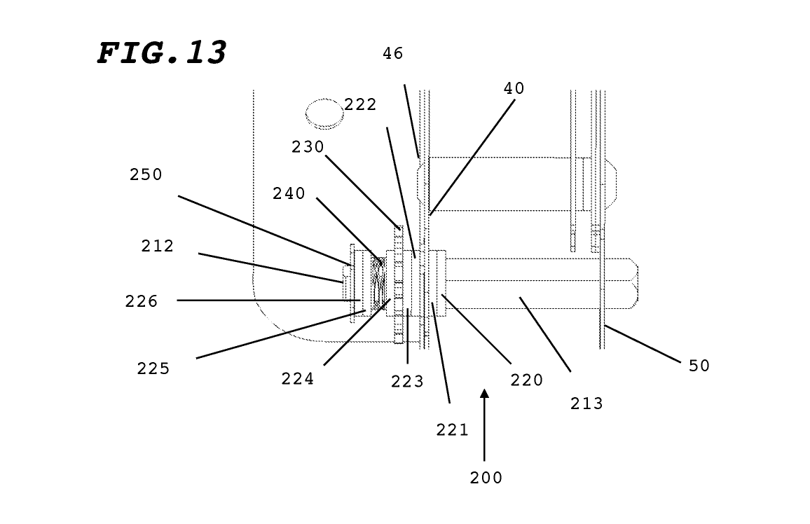

Referring to FIGS. 1-3 and 6-13, an alternative embodiment of a shaft assembly 200 utilized by a cooking device 10 is provided. The front side wall 40 of the cooking device 10 has a second aperture 42 extending therethrough. The shaft assembly 200 has a shaft 210, washers 220, 221, 222, 223, 224, 225, 226, a sprocket 230, a spring 240, and a shaft retainer 250. A spring 240 (shown in FIG. 9) is comparable to the spring 140. Of course, in other alternative embodiments, the springs 140, 240 could be non comparable springs of any suitable configuration, shape or type such as wave or coil springs for example.

22. Referring to FIGS. 1-3 and 6-13, the shaft 210 has a first end 211 and a second end 212. A head 213 is disposed on the first end 211 of the shaft 210. The head 213 is configured to be rotatably coupled and not extend through the second aperture 42 of the front side wall 40. The front side wall 40 has a motor mount 50 coupled thereon. The motor mount 50 has a motor mount aperture 51 extending therethrough. The motor mount aperture 51 corresponds with the second aperture 42 and is sized to allow the head 213 to rotatably extend therethrough. The head 213 is configured to be removably coupled to a device supplying rotational input, for example a handle (not shown) or an electric motor (not shown). Of course, in alternative embodiments, the head 213 could be of any suitable size or shape such as a hexagon for example.

Referring to FIGS. 1-3 and 6-13, the first washer 220 and the second washer 221 are configured to be received respectively by the second end 212 such that they are slidably and rotatably disposed on the shaft 210. An advantage of the shaft assembly 200 is that the second end 212 of the shaft 210 is configured to be received through the second aperture 42 into the inner cooking region 20 such that the shaft 210 is rotatably supported by the second aperture 42 which is less support points than other shaft assemblies. The third and forth washers 222, 223 are configured to be received respectively by the second end 212 such that they are slidably and rotatably disposed on the shaft 210. The shaft 210 (shown in FIG. 11) has a shaft engagement portion 214 that extends therein a predetermined distance from the second end 212. The sprocket 230 (shown in FIG. 10) has a sprocket face 231 that has a sprocket aperture 232 therethrough that is sized and shaped to be received rotatably locked and slidably disposed thereon the shaft engagement portion 214 (shown in FIG. 11). In alternative embodiments, the sprocket 230 could be of a different size, number of teeth. Of course, in alternative embodiments, the sprocket aperture 232 could be of any suitable size or shape such as a triangle for example.

Referring to FIGS. 1-3 and 6-13, the washer 224, spring 240, washer 225 and washer 226 are configured to be received respectively by the second end 212 such that they are slidably and rotatably disposed on the shaft 210. The shaft 210 has a groove 215 therein configured at a predetermined distance from the second end 212 such that when the shaft retainer 250 is received in the groove 215, the spring 240 is compressed and aligns the shaft assembly 200 substantially perpendicular and the sprocket 230 substantially parallel to the front side wall 40 of the cooking device 10 and the endless chain support members 61, 62. An advantage of the shaft assembly 200 is that it is self aligning requiring only the second aperture 42 which is a smaller support structure than other shaft assemblies. Of course, in alternative preferred embodiments, any number of washers 220, 221, 222, 223, 224, 225, 226 potentially could be removed or could be included in different combinations depending on the desired application. In an alternative embodiment, the shaft retainer 250 could be a different retainer such as snap ring or push on retainer for example.

In one preferred embodiment the shaft assembly 100 is constructed of stainless steel, as is the alternative embodiment shaft assembly 200. Of course, in other alternative embodiments, the shaft assembly could be constructed in whole or in combination of other materials such as stainless steel, steel, brass, or ceramic for example. The shaft assembly disclosed herein provides a substantial advantage over other shaft assemblies. In particular, the shaft assembly provides a technical effect of a single point mounting of a substantially perpendicular shaft and a substantially parallel sprocket to a side wall of thinner construction, thus reducing overall number of manufacturing components. In addition the shaft assembly uses of hub-less sprockets and shaft retainers that could be produced by stamping or laser cutting instead of more involved multi axis machining for example hobbing, mill and lathe processes. Further, the shaft assembly could utilize washers as wear surfaces eliminating larger bearings to further reduce manufacturing processes. Another advantage is that washers could be added to enable smooth rotation, reduce machining, adjust spring tension as well as general spacing. One provided alternative shaft assembly also can eliminate the need for secondary processes like tapping set screws for shaft to sprocket engagement by rotatably locking the sprocket to the shaft. Further added benefits include end user assembly and disassembly for maintenance/cleaning. Further unforeseen benefits include the technical effect of chain tensioning and reducing chain speed vibration from the spring maintaining the parallel alignment of the sprocket to the chain support members even if the shaft alignment is deflected by an external source. The present invention can be utilized as a self aligning perpendicular idler assembly and still further, the shaft engagement portion and sprocket can be configured and sized to be utilized as a self aligning perpendicular drive assembly.

While the claimed invention has been described in detail in connection with only a limited number of embodiments, it should be readily understood that the invention is not limited to such disclosed embodiments. Rather, the claimed invention can be modified to incorporate any number of variations, alterations, substitutions or equivalent arrangements not heretofore described, but which are commensurate with the spirit and scope of the invention. Additionally, while various embodiments of the claimed invention have been described, it is to be understood that aspects of the invention could include only some of the described embodiments. Accordingly, the claimed invention is not to be seen as limited by the foregoing description.

1. A cooking device shaft assembly, comprising: a shaft, a sprocket and a spring.

2. The cooking device shaft assembly, of claim 1, further comprising a single rotatably supporting position thereon the shaft.

3. A cooking device shaft assembly, comprising: a shaft, a sprocket, a spring and a shaft retainer; the shaft comprising a first end and a second end; a head being disposed on the first end of the shaft; the head being configured not to extend through a first aperture therethrough a first side wall; the shaft being rotatably supported by the first aperture; the sprocket comprising a sprocket face; the spring and the sprocket being configured to be received by the second end of the shaft and being disposed on the shaft; the shaft retainer configured at a predetermined distance from the second end such that the spring being compressed, aligns the shaft substantially perpendicular and the sprocket face substantially parallel to the first side wall.

4. The cooking device shaft assembly of claim 3, further comprising a first washer disposed on the shaft.

5. The cooking device shaft assembly of claim 3, further comprising a plurality of washers disposed on the shaft.

6. The cooking device shaft assembly of claim 3, wherein the shaft further comprising a groove configured to receive the shaft retainer.

7. The cooking device shaft assembly of claim 6, further comprising a first washer disposed on the shaft.

8. The cooking device shaft assembly of claim 6, further comprising a plurality of washers disposed on the shaft.

9. A cooking device shaft assembly, comprising: a shaft, a sprocket, a spring and a shaft retainer; the shaft comprising a first end and a second end; a head being disposed on the first end of the shaft; the head being configured to be rotatably coupled and not to extend through a first aperture in a first side wall; the shaft being rotatably supported by the first aperture; the sprocket comprising a sprocket face; the sprocket face comprising a sprocket aperture therethrough that is sized and shaped to be received rotatably locked and slidably disposed thereon a shaft engagement portion of the shaft; the spring being configured to be received by the second end of the shaft and being disposed on the shaft; the shaft retainer configured thereon the shaft at a predetermined distance from the second end such that the spring being compressed, aligns the shaft substantially perpendicular and the sprocket face substantially parallel to the first side wall.

10. The cooking device shaft assembly of claim 9, further comprising a first washer disposed on the shaft.

11. The cooking device shaft assembly of claim 9, further comprising a plurality of washers disposed on the shaft.

12. The cooking device shaft assembly of claim 9, wherein the shaft further comprising a groove configured to receive the shaft retainer.

13. The cooking device shaft assembly of claim 12, further comprising a first washer disposed on the shaft.

14. The cooking device shaft assembly of claim 12, further comprising a plurality of washers disposed on the shaft.
